(19) United States
(12) Patent Application Publication
(10) Pub. No.: US 2011/0111167 A1
(43) Pub. Date: May 12, 2011

(54) Buffer Board for a Treadmill

(76) Inventor: Sreter Chang, Hernei Township (TW)

(21) Appl. No.: 12/614,081

(22) Filed: Nov. 6, 2009

(51) Int. Cl. B32B 5/12

(52) U.S. Cl. 428/106

(57) ABSTRACT

A buffer board for a treadmill includes a bamboo strip portion and an endurable slide plate. The bamboo strip portion is composed of at least one longitudinal strip and at least one transverse strip. The longitudinal strip and the transverse strip are crosswise knitted to constitute a bamboo plate. The bamboo plate can be stacked one by one to form a stack of bamboo plates in a desired thickness for enhancing the strength of the buffer board. The endurable slide plate is attached on the bamboo plate or the stack of bamboo plates. A layer of rubber or foam is attached on the endurable slide board. The buffer board is applied to a running belt of the treadmill, with the bamboo plate to provide a better buffer effect.

### BACKGROUND OF THE INVENTION

1. Field of the Invention

The present invention relates to a buffer board, and more particularly to a buffer board for a treadmill, which uses bamboo strips to be knitted crosswise to form a bamboo plate as the buffer board of a treadmill for enhancing a buffer effect.

2. Description of the Prior Art

In general, a conventional treadmill has a buffer board located under a running belt as a support. When the user treads on the running belt, the buffer board bears great applied force. If there is no buffer resilience, the user will feel unconformable. Therefore, an improved treadmill is provided with buffer pads and a buffer device under the buffer board. Besides, a layer of foam is attached on the buffer board and a layer of woven fabric is attached on the layer of foam, providing a smooth turning for a running loop and a comfortable buffer.

The restoration effect of the conventional treadmill is not good, its hardness is great, and the deformation capacity of tread is less. The foot joints of the user may be injured easily when running.

The buffer board of the conventional treadmill is made of hard material, relying on its resilient material, and the buffer pads at four corners of the treadmill are not enough. Therefore, the buffer device is adapted to assist the buffer effect. However, this structure is complicated and the cost is high.

### SUMMARY OF THE INVENTION

According to the present invention, there is provided a buffer board for a treadmill. The buffer board is mounted under a running belt of the treadmill. The buffer board comprises a bamboo strip portion and an endurable slide plate. The bamboo strip portion is composed of at least one longitudinal strip and at least one transverse strip. The longitudinal strip and the transverse strip are crosswise knitted to constitute a bamboo plate. The endurable slide plate is attached on the bamboo plate.

Preferably, the numbers of the longitudinal strip and the transverse strip depend on the weight and the area of a load.

Preferably, the bamboo plate is constituted by one longitudinal bamboo strip and one transverse bamboo strip which are crosswise knitted.

Preferably, the bamboo plate is constituted by two longitudinal bamboo strips and two transverse bamboo strips which are crosswise knitted.

Preferably, the bamboo plate is constituted by three longitudinal bamboo strips and three transverse bamboo strips which are crosswise knitted.

Preferably, the bamboo plate is stacked with at least another bamboo plate to constitute a stack of bamboo plates.

Preferably, a layer of rubber or foam is attached on the bamboo plate, and the endurable slide plate is attached on the layer of rubber or foam.

The present invention uses the bamboo plate composed of the longitudinal strip and the transverse strip and the endurable slide plate as the buffer board of the running belt of the treadmill.

The bamboo plate of the present invention can be constituted by a stack of bamboo plates for enhancing the strength of the buffer board.

The buffer board of the present invention includes the bamboo plate or the stack of bamboo plates, the layer of rubber or foam attached on the bamboo plate, and the endurable slide plate attached on the layer of rubber or the foam.

Compared to the prior art, the buffer board of the present invention uses the bamboo plate composed of the knitted longitudinal and transverse strips to provide a better buffer effect.

### BRIEF DESCRIPTION OF THE DRAWINGS

FIG. 1-A is a perspective view of a bamboo plate according to a first embodiment of the present invention;

FIG. 1-B is a perspective view of a bamboo plate according to a second embodiment of the present invention;

FIG. 1-C is a perspective view of a bamboo plate according to a third embodiment of the present invention;

FIG. 2 is a schematic view showing a stack of bamboo plates which are bonded together;

FIG. 3 is a schematic view showing a buffer board which is constituted by at least one layer of bamboo plate;

FIG. 3-A is a cross-sectional view of a buffer board according to a first embodiment of the present invention;

FIG. 3-B is a cross-sectional view of a buffer board according to a second embodiment of the present invention; and

FIG. 4 is a perspective view showing the present invention applied to a treadmill.

### DETAILED DESCRIPTION OF THE PREFERRED EMBODIMENTS

Embodiments of the present invention will now be described, by way of example only, with reference to the accompanying drawings.

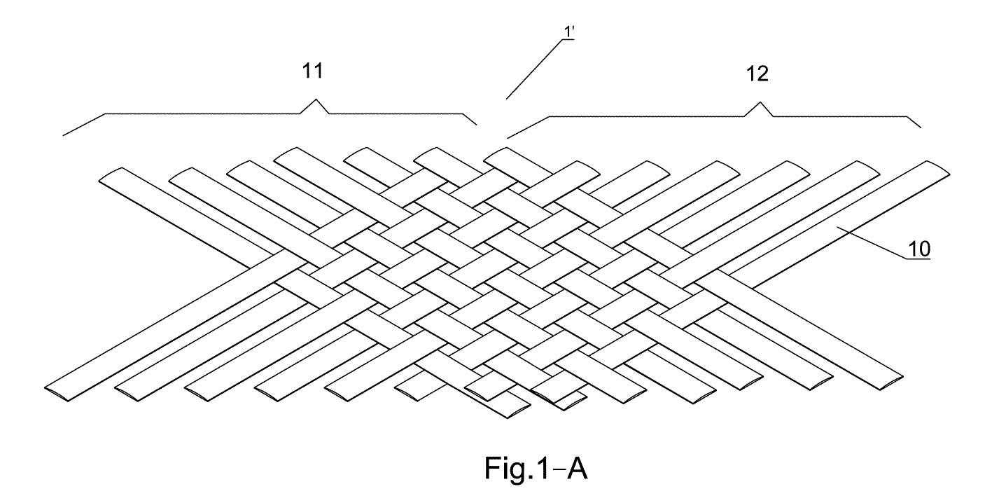

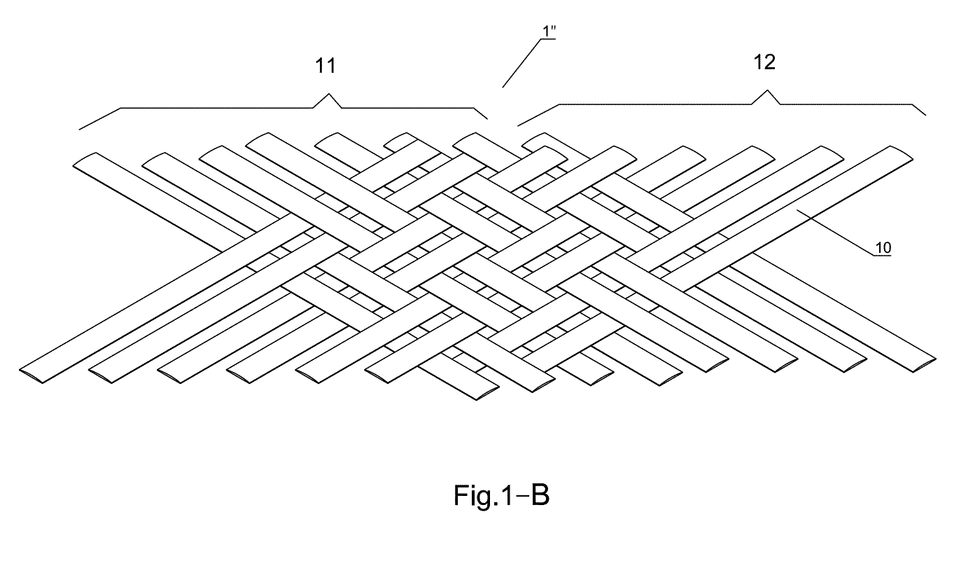

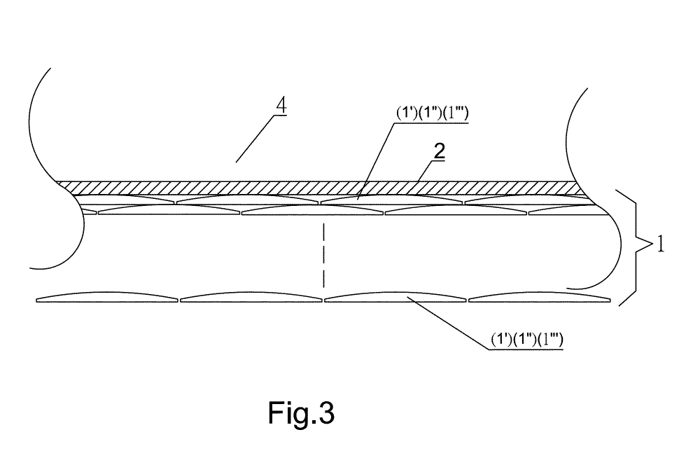

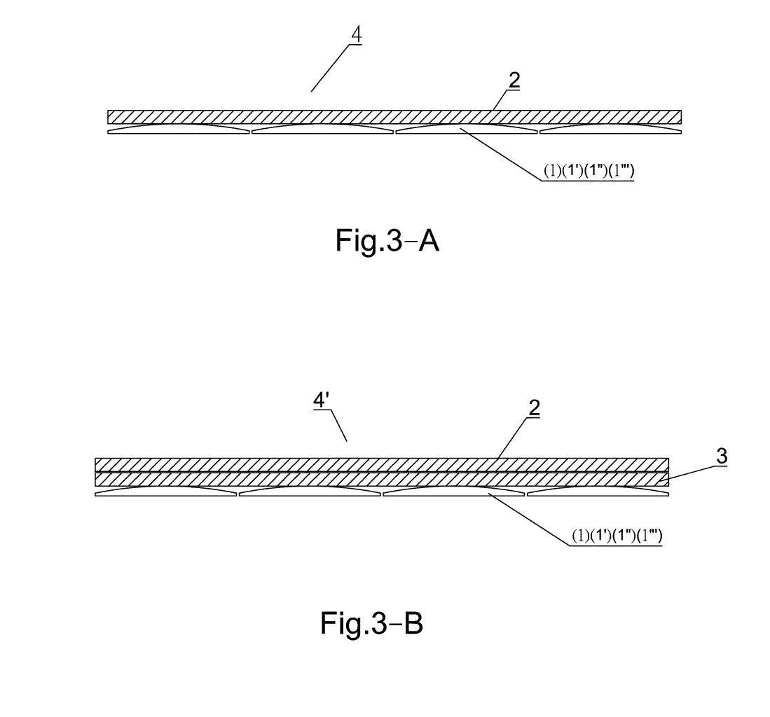

As shown in FIGS. 1-A, 1-B, 1-C, the present invention uses bamboo strips 10 to constitute a bamboo plate 1′, 1″, 1′″. The bamboo strips 10 includes at least one longitudinal bamboo strip 11 and at least one transverse bamboo strip 12 which are crosswise knitted with one another. The bamboo plate 1′, 1″, 1′″ is attached with an endurable slide plate 2 to form a buffer board 4, as shown in FIG. 3 and FIG. 3A. The bamboo plate 1′, 1″, 1′″ has resilience and a better restoration character as the buffer board 4 for a running belt 51 of a treadmill 5 so that the user can run comfortably.

Referring to FIGS. 1-A, 1-B, 1-C, the numbers of the longitudinal bamboo strip 11 and the transverse bamboo strip 12 depend on the weight of a desired load so as to provide an appropriate buffer effect.

Referring to FIG. 1-A, the bamboo plate 1′ is crosswise knitted by one longitudinal bamboo strip 11 and one transverse bamboo strip 12.

Referring to FIG. 1-B, the bamboo plate 1″ is crosswise knitted by two longitudinal bamboo strips 11 and two transverse bamboo strips 12.

Referring to FIG. 1-C, the bamboo plate 1′″ is crosswise knitted by three longitudinal bamboo strip 11 and three transverse bamboo strips 12.

Accordingly, the required numbers of the longitudinal bamboo strips 11 and the transverse bamboo strips 12 are analogized by the desired buffer effect. No matter what type of bamboo plate 1′, 1″, 1′″ is generally called a bamboo plate 1. Therefore, the at least one longitudinal bamboo strip 11 and the at least one transverse bamboo strip 12 are able to disperse tread impact, providing a balance buffer effect.

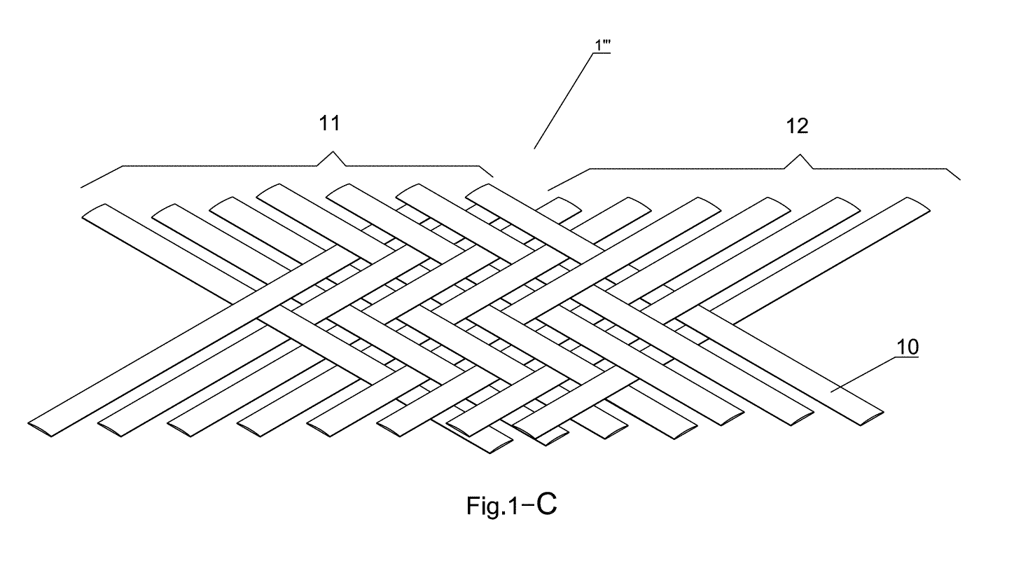

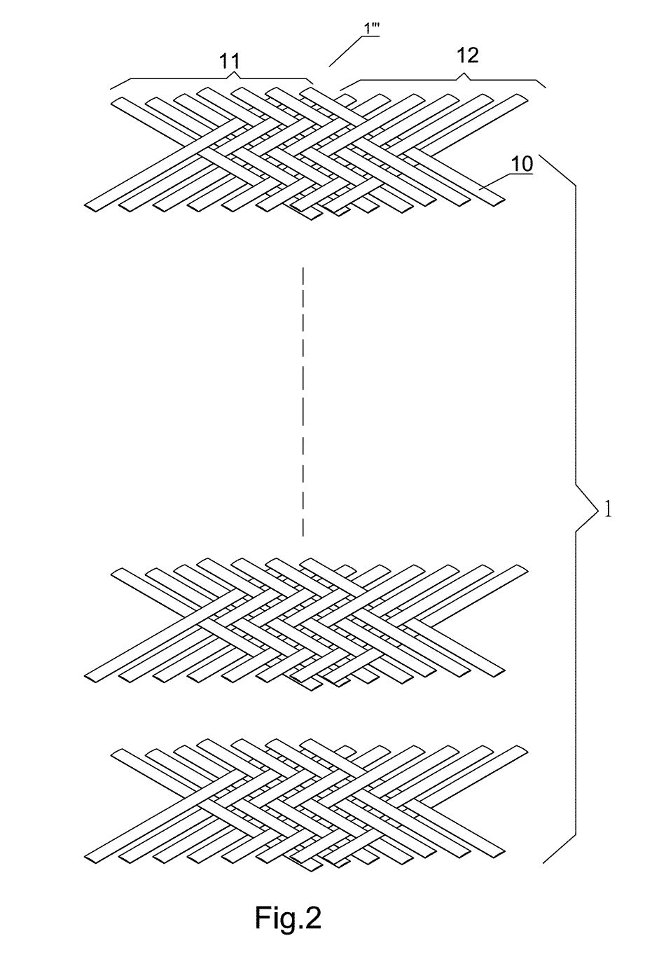

Referring to FIGS. 2, 3, 3-A, 3-B, the bamboo plate 1 in a stack according to the bamboo plate 1′, 1″, 1′″ of the aforesaid embodiments can be constituted by at least one layer of the bamboo plate 1′, 1″, 1′″ according to a desired thickness and strength, and then attached with the endurable slide plate 2 so as to strengthen the buffer board 4 and maintain its resilience.

FIGS. 3 and 3-B show a second embodiment of the buffer board 4′, which includes the bamboo plate 1′, 1″, 1′″ or the bamboo plate 1, a layer of rubber or foam 3 attached on the bamboo plate 1′, 1″, 1′″ or the bamboo plate 1, and the endurable slide plate 2 attached on the layer of rubber or the foam 3.

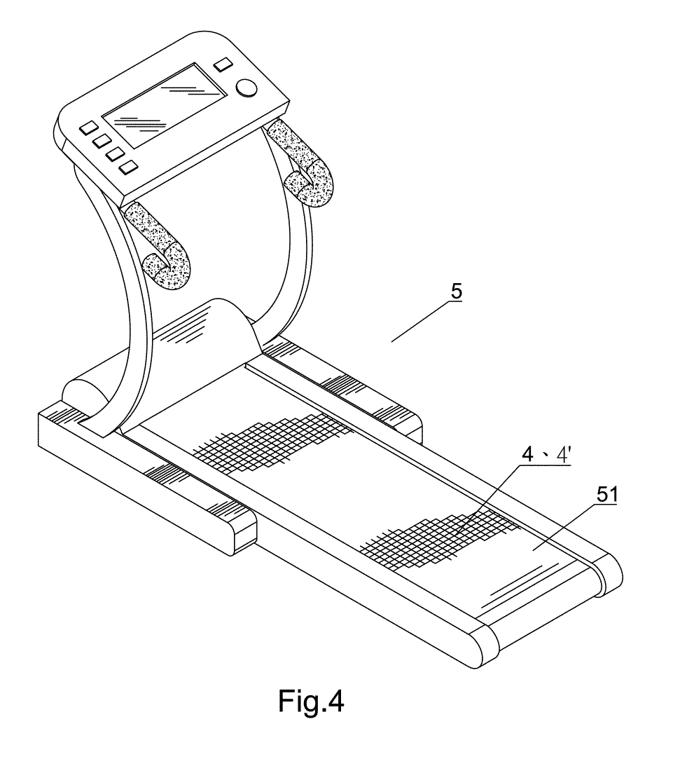

Referring to FIG. 4, the buffer board 4, 4′ is disposed under the running belt 51 of the treadmill 5. The bamboo plate 1′, 1″, 1′″ or the bamboo plate 1 has a better resilience and a better buffer effect so that the user can tread on the running belt 51 comfortably.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A buffer board for a treadmill, mounted under a running belt of the treadmill, the buffer board comprising: a bamboo strip portion and an endurable slide plate, the bamboo strip portion being composed of at least one longitudinal strip and at least one transverse strip, the longitudinal strip and the transverse strip being crosswise knitted to constitute a bamboo plate, the endurable slide plate being attached on the bamboo plate.

2. The buffer board for a treadmill as claimed in claim 1, wherein the numbers of the longitudinal strip and the transverse strip depend on the weight and the area of a load.

3. The buffer board for a treadmill as claimed in claim 2, wherein the bamboo plate is constituted by one longitudinal bamboo strip and one transverse bamboo strip which are crosswise knitted.

4. The buffer board for a treadmill as claimed in claim 2, wherein the bamboo plate is constituted by two longitudinal bamboo strips and two transverse bamboo strips which are crosswise knitted.

5. The buffer board for a treadmill as claimed in claim 2, wherein the bamboo plate is constituted by three longitudinal bamboo strips and three transverse bamboo strips which are crosswise knitted.

6. The buffer board for a treadmill as claimed in claim 1, wherein the bamboo plate is stacked with at least another bamboo plate to constitute a stack of bamboo plates.

7. The buffer board for a treadmill as claimed in claim 1, wherein a layer of rubber or foam is attached on the bamboo plate, and the endurable slide plate is attached on the layer of rubber or foam.
